(19) United States
(12) Patent Application Publication
(10) Pub. No.: US 2012/0106648 A1
(43) Pub. Date: May 3, 2012

(54) IMAGE PROCESSING DEVICE AND VIDEO REPRODUCING DEVICE

(76) Inventor: Kazuaki Terashima, Kanagawa (JP)

(21) Appl. No.: 13/382,258

(22) PCT Filed: Sep. 2, 2009
(86) PCT No.: PCT/JP2009/065292

§ 371 Date: Jan. 4, 2012

(51) Int. Cl. H04N 7/26

(52) U.S. Cl. 375/240.16; 375/E07.125

(57) ABSTRACT

An image processing device and a video reproducing device capable of detecting the position of a character in a moving image even if pixels of the character have a luminance not higher than a luminance of pixels other than the pixels of the character are provided. A motion vector generation unit generates motion vectors of an image of a first frame and an image of a second frame. An edge detection unit detects an edge pixel forming an edge of the image of the first frame. A character position detection unit detects a position of a character included in the image of the first frame based on a motion vector, a luminance, and information about whether or not being the edge pixel, of each pixel of the image of the first frame.

### TECHNICAL FIELD

The present invention relates to an image processing device, and more particularly to an image processing device and a video reproducing device having the function of detecting the position of a character in a moving image.

### BACKGROUND ART

Devices for detecting the position of a character included in a moving image have been proposed. For example, Patent Literature 1 (Japanese Patent Laying-Open No. 2009-42897) discloses an image processing device for detecting the positions of characters to be scrolled. In this image processing device, an extraction unit extracts a region having a luminance higher than a predetermined value as a character region from an input image. A motion vector calculation unit divides the image into blocks of a plurality of rows and a plurality of columns, and calculates motion vectors corresponding to blocks including the character region extracted by the extraction unit. If there are more than a predetermined number of blocks having motion vectors of the same magnitude and direction in the same row or column, a scroll determination unit determines that there are characters to be scrolled in the row or column.

### CITATION LIST

### Patent Literature

PTL 1: Japanese Patent Laying-Open No. 2009-42897

### SUMMARY OF INVENTION

### Technical Problem

The device of Patent Literature 1, however, is based on the premise that pixels of the characters have a luminance higher than a luminance of pixels other than the pixels of the characters. There are numerous moving images not based on this premise, and the position of a character cannot be detected for such moving images.

Thus, an object of the present invention is to provide an image processing device and a video reproducing device capable of detecting the position of a character in a moving image even if pixels of the character have a luminance not higher than a luminance of pixels other than the pixels of the character.

### Solution to Problem

An image processing device in an embodiment of the present invention includes a motion vector generation unit for generating motion vectors of an image of a first frame and an image of a second frame, an edge detection unit for detecting an edge pixel forming an edge of the image of the first frame, and a character position detection unit for detecting a position of a character included in the image of the first frame based on a motion vector, a luminance, and information about whether or not being the edge pixel, of each pixel of the image of the first frame.

### Advantageous Effects of Invention

According to an embodiment of the present invention, the position of a character in a moving image can be detected even if pixels of the character have a luminance not higher than a luminance of pixels other than the pixels of the character.

### BRIEF DESCRIPTION OF DRAWINGS

FIG. 1 shows a configuration of an image processing device in an embodiment of the present invention.

FIG. 2 is a flowchart showing an operation procedure of the image processing device in the embodiment of the present invention.

FIG. 3(a) shows an example of an image of a previous frame.

FIG. 3(b) shows an example of an image of a current frame.

FIG. 4 illustrates an example of a histogram.

FIG. 5 illustrates an example of specifying a character line.

FIG. 6 shows character outline pixels generated from a combination Cb2.

FIG. 7 shows character pixels generated from the character outline pixels in FIG. 6.

FIG. 8 is a flowchart showing details of step S103 in the flowchart of FIG. 2.

FIG. 9 illustrates an example of detection of edge pixels.

FIG. 10 is a flowchart showing details of step S107 in the flowchart of FIG. 2.

FIG. 11 is a flowchart showing details of step S114 in the flowchart of FIG. 2.

FIG. 12 shows an example of motion vectors of character pixels included in one character line.

FIG. 13 shows an example of an image of a frame at time T1.

FIG. 14 shows an example of the image of the frame at time T2.

FIG. 15 shows a block configuration of a substantial part of a video reproducing device and system.

### DESCRIPTION OF EMBODIMENTS

An embodiment of the present invention will be described hereinafter with reference to the drawings.

(Configuration)

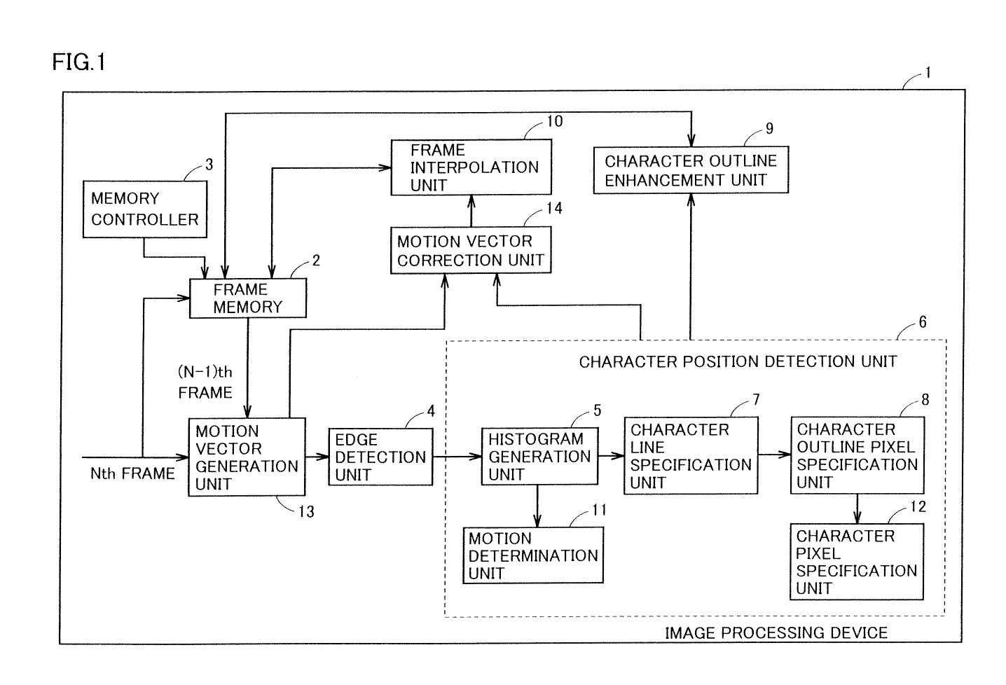

FIG. 1 shows a configuration of an image processing device in the embodiment of the present invention.

Referring to FIG. 1 an image processing device 1 includes a frame memory 2, a memory controller 3, a motion vector generation unit 13, an edge detection unit 4, a character position detection unit 6, a motion vector correction unit 14, a frame interpolation unit 10, and a character outline enhancement unit 9.

Frame memory 2 stores an externally input image. Frame memory 2 outputs an image of a frame immediately previous to a current frame to motion vector generation unit 13.

Memory controller 3 controls input of an image to frame memory 2, and output of an image from frame memory 2.

Edge detection unit 4 horizontally scans an image of a current frame, and if there is a segment including a predetermined number or more of continuous pixels having a value equal to or greater than a threshold value, detects both ends of the segment as edge pixels.

Character position detection unit 6 detects the position of a character based on a frequency with which pixels having a motion vector and a luminance forming a combination are edge pixels, for each combination of a motion vector and a luminance of the image of the current frame. Character position detection unit 6 includes a histogram generation unit 5, a character line specification unit 7, a motion determination unit 11, a character outline pixel specification unit 8, and a character pixel specification unit 12.

Histogram generation unit 5 generates a histogram representing a frequency with which pixels having a motion vector and a luminance forming a combination are edge pixels, for each combination of a motion vector and a luminance of the image.

Character line specification unit 7 specifies a combination of a motion vector and a luminance having a histogram frequency equal to or higher than a threshold value, and specifies, from among a plurality of horizontal lines forming the image of the current frame, lines including a number of pixels equal to or greater than a threshold value having the luminance forming the specified combination as character lines including pixels of a character.

Motion determination unit 11 determines whether the character lines include pixels of a static character or pixels of a moving character, based on magnitude of the motion vector forming the combination of the motion vector and the luminance having the histogram frequency equal to or higher than the threshold value.

Character outline pixel specification unit 8 specifies, from among the plurality of pixels included in the character lines, pixels that are edge pixels as character outline pixels forming an outline of the character.

Character pixel specification unit 12 specifies, if the plurality of character outline pixels forming one character line successively include a pair from one end (left end) of the one character line, two pixels forming the pair and a pixel sandwiched between the two pixels forming the pair as character pixels forming the character.

Character outline enhancement unit 9 performs enhancement processing on the character outline pixels. Character outline enhancement unit 9 varies a degree of enhancement depending on whether the character outline pixels form a static character or a moving character.

Motion vector correction unit 14 specifies a representative vector representing motion vectors of the plurality of character pixels included in one character line, and corrects any of the motion vectors not identical to the representative vector of the plurality of character pixels included in the one character line to the representative vector.

Frame interpolation unit 10 uses the corrected motion vector to generate an image of an intermediate frame between the previous frame and the current frame from the image of the previous frame.

(Operation)

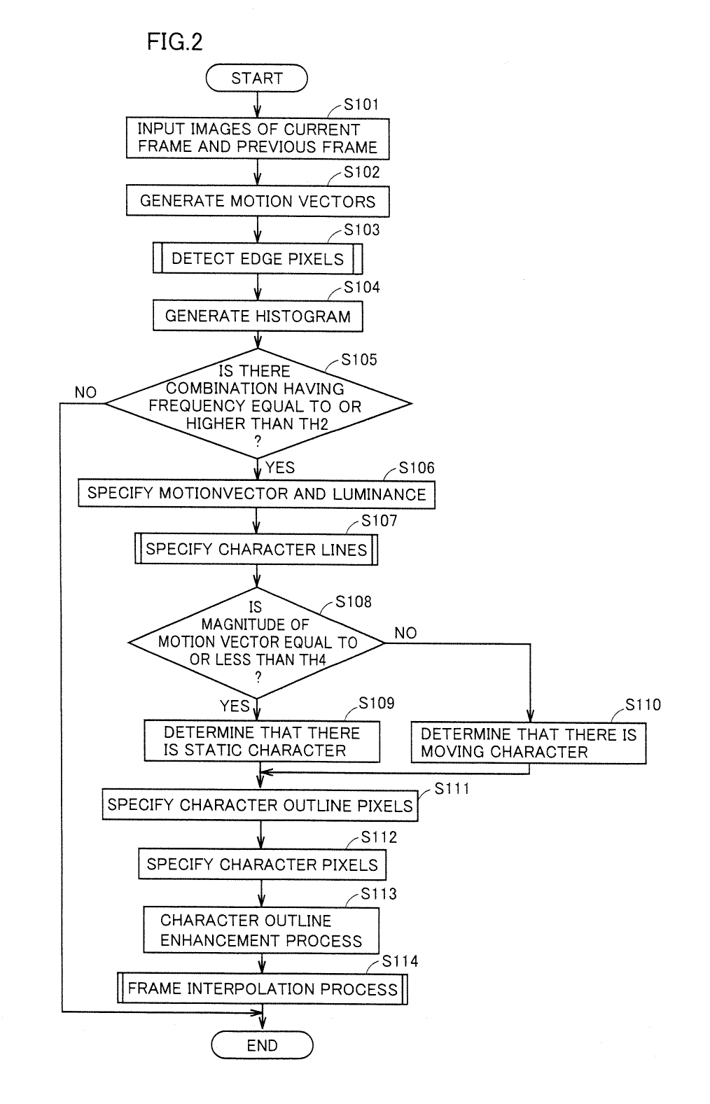

FIG. 2 is a flowchart showing an operation procedure of the image processing device in the embodiment of the present invention.

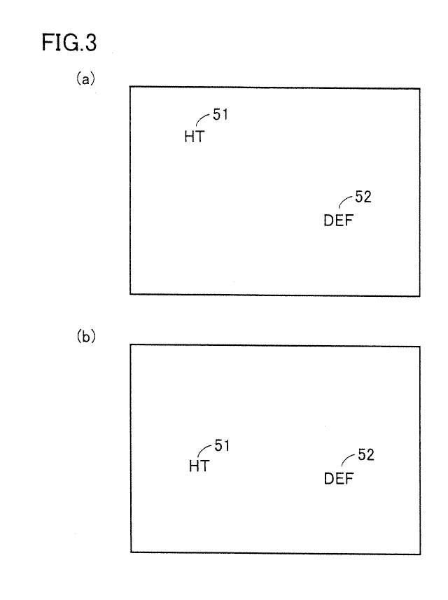

Referring to FIG. 2, motion vector generation unit 13 externally receives an image of a current frame (the Nth frame), and receives an image of a previous frame (the (N−1)th frame) from frame memory 2. FIG. 3(a) shows an example of the image of the previous frame. FIG. 3(b) shows an example of the image of the current frame. Here, the positions of pixels forming a character string “HT” have changed, and the positions of pixels forming a character string “DEF” have not changed (step S101).

Next, motion vector generation unit 13 generates a motion vector of each pixel in the input two images (step S102).

Next, edge detection unit 4 detects edge pixels forming an edge of the image of the current frame (the Nth frame) (step S103).

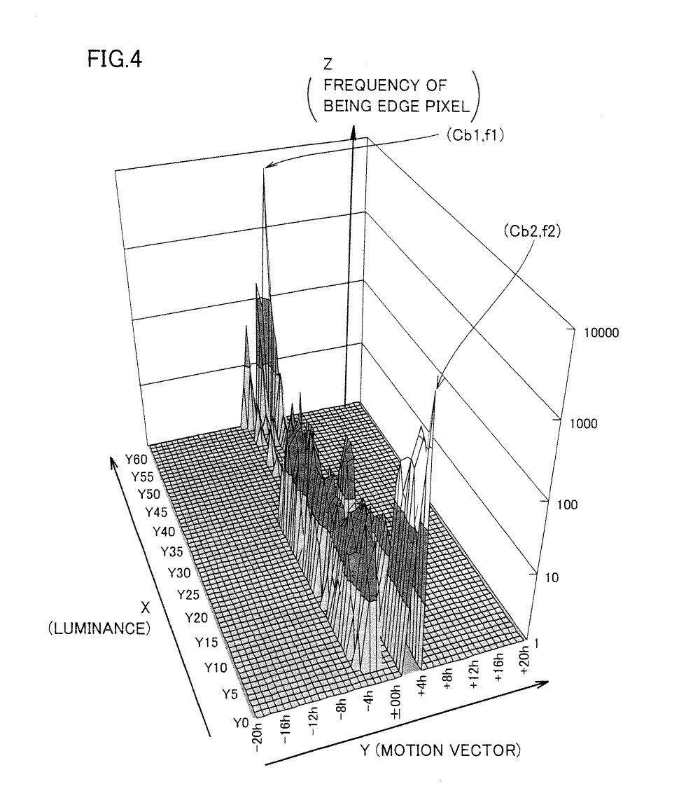

Next, histogram generation unit 5 generates a histogram representing a frequency with which pixels having a motion vector and a luminance forming a combination are edge pixels, for each combination of the motion vector between the current frame and the previous frame generated in step S102 and a luminance of the current frame. More specifically, with a luminance represented in an X-axis and a motion vector represented in a Y-axis as shown in FIG. 4, histogram generation unit 5 relates a frequency, with which pixels are edge pixels with respect to the combination of the luminance and the motion vector, to a Z-axis.

For example, if there are two pixels having a luminance of x and a motion vector of y, with both pixels being edge pixels, a value (frequency) of z with respect to (x, y) is 2. If only one of the pixels is an edge pixel, the value (frequency) of z with respect to (x, y) is 1. If neither of the pixels is an edge pixel, the value (frequency) of z with respect to (x, y) is 0.

Actually, however, a motion vector is two-dimensional, and thus the Y-axis includes a Y1-axis and a Y2-axis. Thus, a frequency z with respect to (x, y1, y2) is actually obtained. The reason that such histogram was generated is based on the premise that all pixels forming character strings such as the character string “DEF” or the character string “HT” usually have the same luminance and motion vectors of the same magnitude, and that these character strings include many edge pixels. Accordingly, by specifying a combination of a luminance and a motion vector having a high frequency, it can be understood that a character string including pixels having the specified luminance and motion vector exists in an image (step S104).

Next, if there is one or more combinations of a luminance and a motion vector having a frequency equal to or higher than a threshold value TH2 (YES in step S105), character line specification unit 7 specifies the combination having the frequency. In the example of FIG. 4, there are a combination Cb1 of a luminance and a motion vector corresponding to a frequency f1, and a combination Cb2 of a luminance and a motion vector corresponding to a frequency f2. Frequency f1 results from the character “DEF” in FIG. 3. Frequency f2 results from the character “HT” in FIG. 3 (step S106).

The following processing is performed on each specified combination.

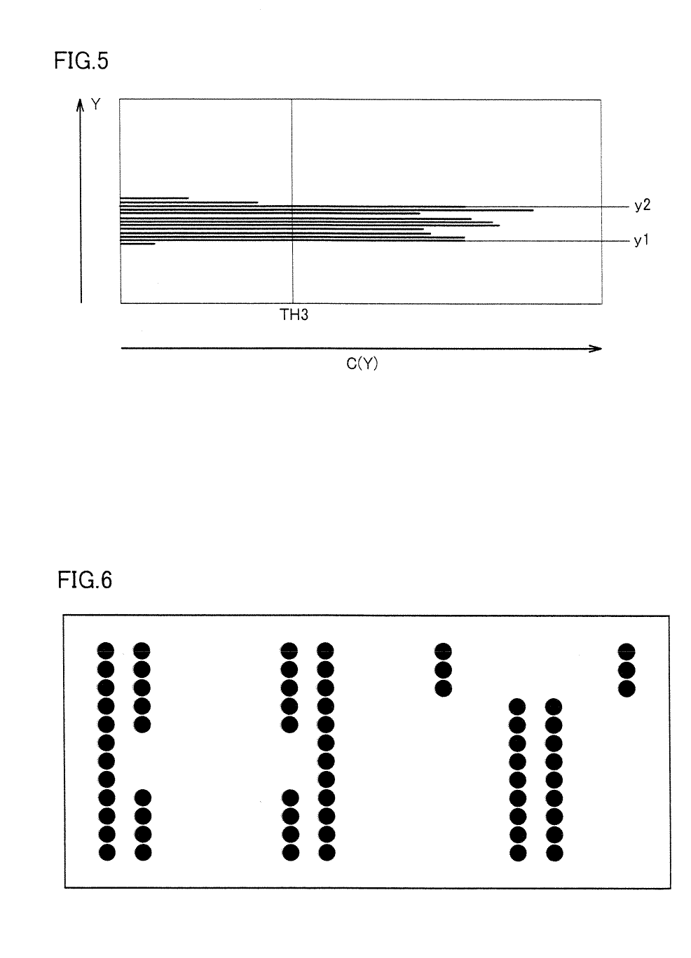

First, character line specification unit 7 specifies, from among a plurality of horizontal lines (vertical position Y) forming the image of the current frame, lines including a number C (Y) of pixels equal to or higher than a threshold value TH3 having the luminance forming the specified combination as character lines including pixels of a character. FIG. 5 illustrates an example of specifying character lines. In FIG. 5, a vertical position of the lines having C (Y) equal to or higher than threshold value TH3 is between y1 and y2, and thus lines in vertical position y that satisfy y1≦y≦y2 are specified as character lines. In this manner, by using the luminance, which is one of the elements of the combination of the motion vector and the luminance having the histogram frequency equal to or higher than the threshold value, the character lines including the pixels of the character can be readily detected (step S107).

If the magnitude of the motion vector forming the specified combination is equal to or less than a threshold value TH4 (YES in step S108), motion determination unit 11 determines that the specified character lines include a static character (i.e., a character whose position is not changed between the previous frame and the current frame) (step S109), and if the magnitude is greater than threshold value TH4 (NO in step S108), motion determination unit 11 determines that the character lines include a moving character (i.e., a character whose position is changed between the previous frame and the current frame). In the example of the histogram shown in FIG. 4, the magnitude of the motion vector forming combination Cb1 is equal to or less than threshold value TH4, and it is thus determined that character lines generated from combination Cb1 include pixels of a static character. On the other hand, the magnitude of the motion vector forming combination Cb2 is greater than threshold value TH4, and it is thus determined that character lines generated from combination Cb2 include pixels of a moving character. In this manner, by using the motion vector, which is the other element of the combination of the motion vector and the luminance having the histogram frequency equal to or higher than the threshold value, whether the character lines include pixels of a static character or pixels of a moving character can be readily determined (step S110).

Next, character outline pixel specification unit 8 specifies, from among the plurality of pixels included in the specified character lines, pixels which are edge pixels as character outline pixels forming an outline of the character. FIG. 6 shows character outline pixels generated from combination Cb2. As such, the character outline pixels can be readily extracted from the character lines (step S111).

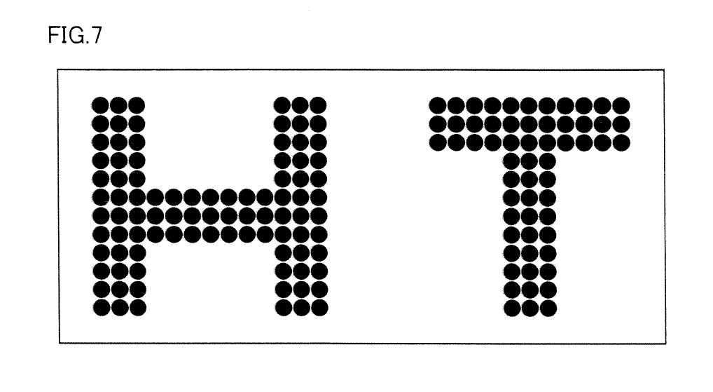

Next, character pixel specification unit 12 specifies, if the plurality of character outline pixels forming one character line successively include a pair from one end (left end) of the one character line, two pixels forming the pair and a pixel sandwiched between the two pixels forming the pair as character pixels forming the character. FIG. 7 shows character pixels generated from the character outline pixels in FIG. 6. As such, the character pixels can be readily extracted from the character lines (step S112).

Next, character outline enhancement unit 9 performs enhancement processing on the specified character outline pixels. For example, character outline enhancement unit 9 multiplies the luminance of a character outline pixel of a static character by a factor of k1 (k1>1), and multiplies the luminance of pixels horizontally adjacent to the character outline pixel by a factor of k2 (k2<1). Further, character outline enhancement unit 9 multiplies the luminance of a character outline pixel of a moving character by a factor of k3 (k3>k1), and multiplies the luminance of pixels horizontally adjacent to the character outline pixel by a factor of k4 (k4<k2). As such, the outline of the character can be readily identified. A moving character, whose outline is difficult to be identified because of movement and which characteristically exhibits unnoticeable noise even when enhanced, can be enhanced to a high degree. A static character, whose outline is easy to be identified and which characteristically exhibits noticeable noise when enhanced, can be enhanced to a degree lower than that for a moving character (step S113).

Next, motion vector correction unit 14 and frame interpolation unit 10 correct the motion vectors and interpolate frames, respectively, to generate an image of an intermediate frame between the current frame and the previous frame (step S114).

(Edge Detection)

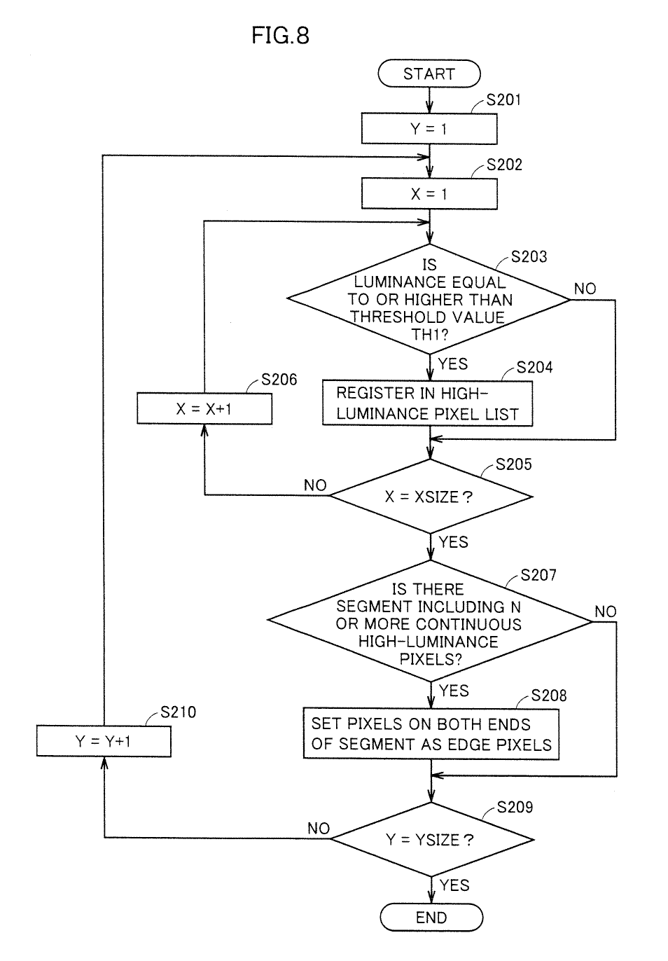

FIG. 8 is a flowchart showing details of step S103 in the flowchart of FIG. 2.

Referring to FIG. 8, first, edge detection unit 4 sets vertical position Y to 1 (step S201).

Next, edge detection unit 4 sets a horizontal position X to 1 (step S202).

Next, if a pixel in a (X, Y) position has a luminance equal to or higher than a threshold value TH1 (YES in step S203), edge detection unit 4 registers the position of the pixel in a high-luminance pixel list (step S204).

Next, if horizontal position X is not equal to a horizontal size XSIZE of the image (NO in step S205), edge detection unit 4 increments horizontal position X by 1 (step S206), and returns to step S203. If horizontal position X is equal to horizontal size XSIZE of the image (YES in step S205), edge detection unit 4 proceeds to the next step S207.

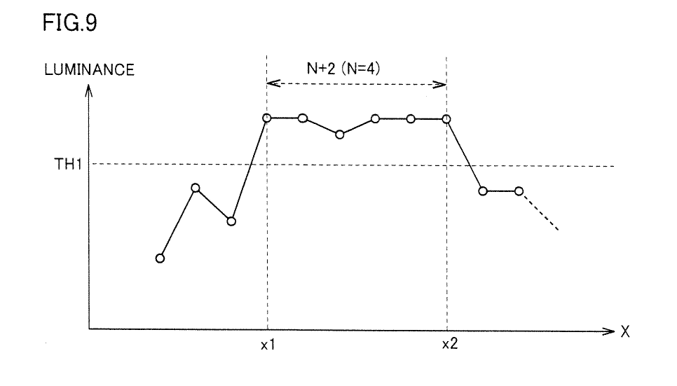

Next, if there is a segment including N or more continuous high-luminance pixels in vertical position Y with reference to the high-luminance pixel list (YES in step S207), edge detection unit 4 detects both ends of the segment as edge pixels. For example, if there is a segment including N (four in this case) or more continuous pixels having a value equal to or greater than threshold value TH1 in a horizontal direction, as shown in FIG. 9, a pixel in a horizontal position of x1 and a pixel in a horizontal position of x2 which are pixels on both ends of the segment are set as edge pixels. As such, the edge pixels can be readily extracted (step S208).

Next, if vertical position Y is not equal to a vertical size YSIZE of the image (NO in step S209), edge detection unit 4 increments vertical position Y by 1 (step S210), and returns to step S202. If vertical position Y is equal to vertical size YSIZE of the image (YES in step S209), edge detection unit 4 ends the process.

(Specification of Character Line)

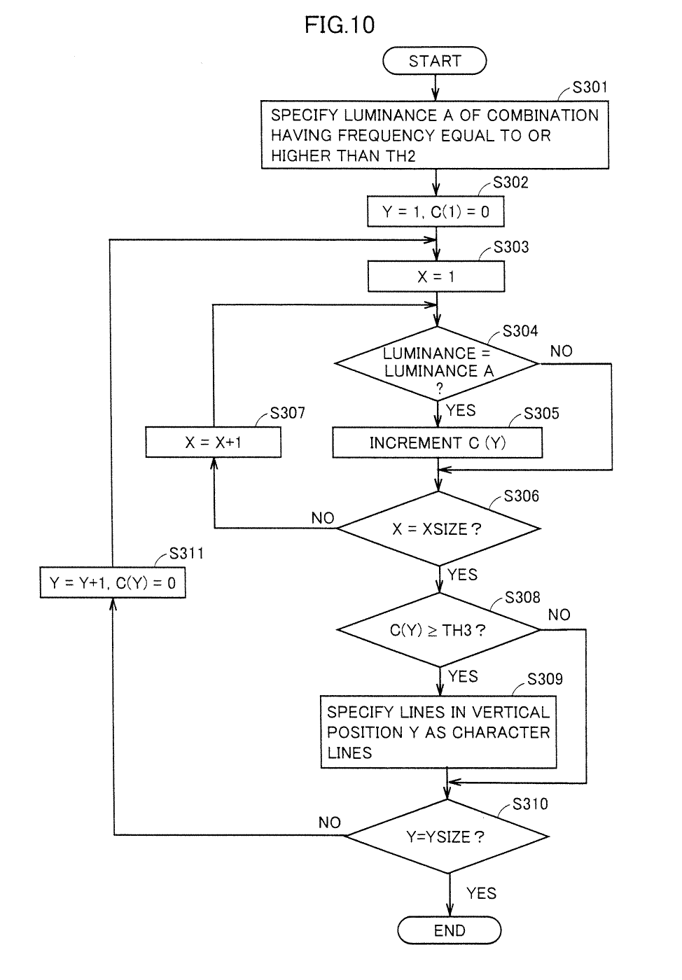

FIG. 10 is a flowchart showing details of step S107 in the flowchart of FIG. 2.

Referring to FIG. 10, character line specification unit 7 specifies a luminance A forming a combination of a luminance and a motion vector having a histogram frequency equal to or higher than threshold value TH2.

Next, character line specification unit 7 sets vertical position Y to 1, and sets a count C(1) to 0 (step S302).

Next, character line specification unit 7 sets horizontal position X to 1 (step S304).

Next, if the pixel in the (X, Y) position has luminance A (YES in step S304), character line specification unit 7 increments count C (Y) by 1 (step S305).

Next, if horizontal position X is not equal to horizontal size XSIZE of the image (NO in step S306), character line specification unit 7 increments horizontal position X by 1 (step S307), and returns to step S304. If horizontal position X is equal to horizontal size XSIZE of the image (YES in step S306), character line specification unit 7 proceeds to the next step S308.

Next, if count value C(Y) is equal to or higher than threshold value TH3 (YES in step S308), character line specification unit 7 specifies lines in vertical position Y as character lines (step S309).

Next, if vertical position Y is not equal to vertical size YSIZE of the image (NO in step S310), character line specification unit 7 increments vertical position Y by 1, sets count C (Y) to 0 (step S311), and returns to step S303. If vertical position Y is equal to vertical size YSIZE of the image (YES in step S310), character line specification unit 7 ends the process.

(Frame Interpolation)

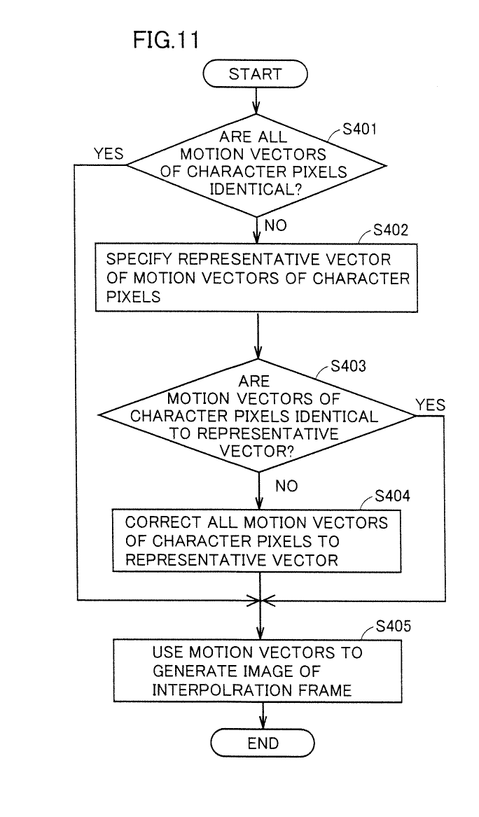

FIG. 11 is a flowchart showing details of step S114 in the flowchart of FIG. 2.

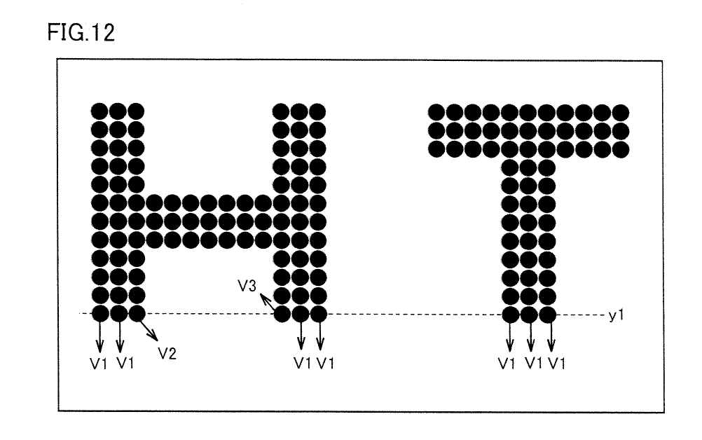

Referring to FIG. 11, first, if motion vectors of a plurality of character pixels included in one character line are not identical (NO in step S401), motion vector correction unit 14 specifies a representative vector representing the motion vectors of the character pixels in the character line. More specifically, motion vector correction unit 14 specifies a motion vector having the highest frequency among the motion vectors of the plurality of character pixels in the one character line as a representative vector. FIG. 12 shows an example of motion vectors of character pixels included in one character line. In this figure, some of character pixels in a character line in vertical position y1 have a motion vector V1, one of them has a motion vector V2, and one of them has a motion vector V3. Since motion vector V1 has the highest frequency in this case, V1 is set as a representative vector (step S402).

Next, if any of the motion vectors of the character pixels included in the character line is not identical to the representative vector (NO in step S403), motion vector correction unit 14 corrects the motion vector to the representative vector. In FIG. 12, the motion vectors of the pixel having motion vector V2 and the pixel having motion vector V3 are corrected to V1. As such, when generating the intermediate frame by using the motion vectors, the occurrence of noise in the image of the intermediate frame after interpolation can be prevented when the motion vectors include noise (step S404).

Next, frame interpolation unit 10 uses the motion vectors to generate an image of the intermediate frame between the previous frame and the current frame from the image of the previous frame. As such, a frame rate can be doubled (step S405).

(Image Processing)

Next, image processing that can be performed when the position of a character is detected with the above-described image processing device will be specifically described. The above-described image processing device is used for image processing in a television, for example. Various noises occur in a digital television due to image compression. Since the compression is carried out in blocks with image compression algorithms, an increase in compression ratio of an image results in the loss of continuity with surrounding blocks, causing a boundary portion to be visible and the occurrence of block noise. Further, mosquito noise occurs in an edge pixel and a pixel where a color varies significantly. Furthermore, when focusing on a character, if a background and a character have similar colors, an edge portion between the character and the background becomes unclear, which may result in a blurred outline of the character.

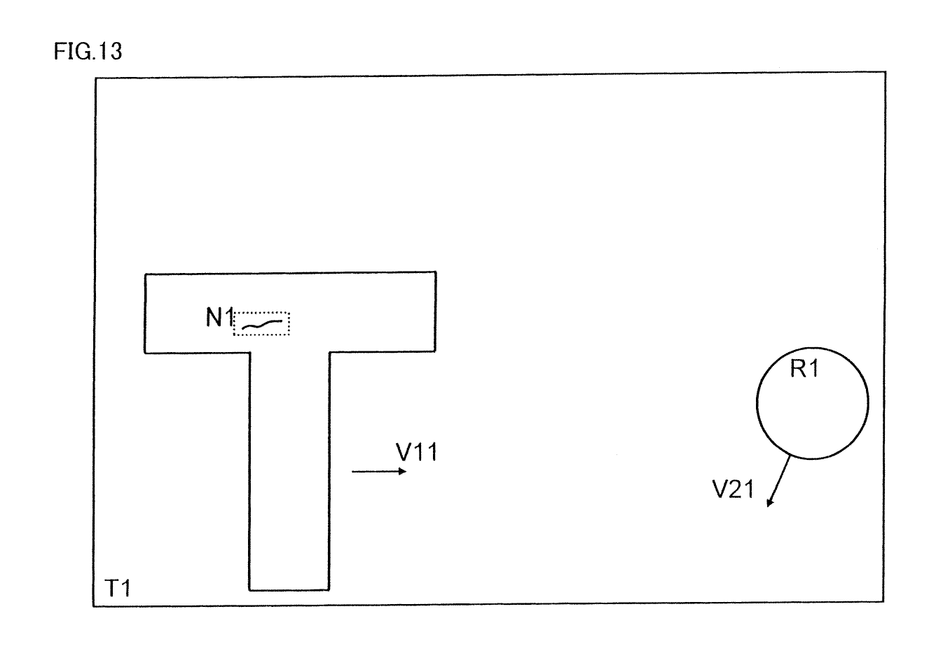

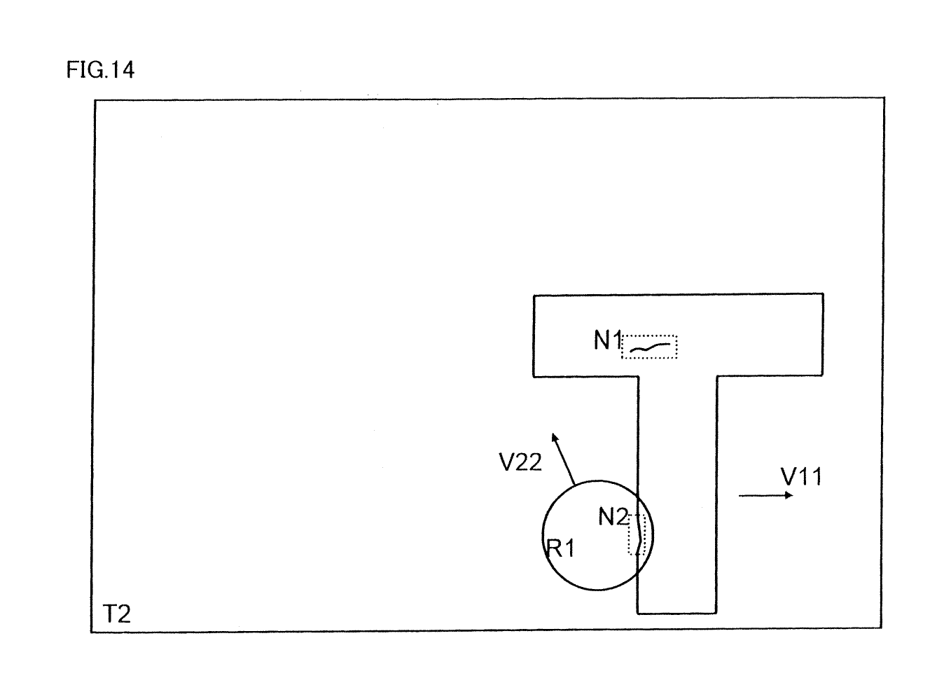

FIG. 13 shows an example of an image of a frame at time T1. FIG. 14 shows an example of the image of the frame at time T2. For brevity of description, edge pixels of a character “T” and a background region R1 are circled and shown as pixel regions, respectively.

In FIGS. 13 and 14, the character “T” has a vector V11, and displayed as a character. The character “T” includes a noise region N1. This image also includes background region R1 having a color similar to that of the character “T”. Background region R1 has a motion vector V21 at time T1, and a motion vector V22 at time T2.

At time T1, the edge pixels of the character “T” can be clearly displayed. At time T2, the character “T” and a partial area of background region R1 overlap each other. Here, since the character “T” overlaps background region R1 having the similar color, partial edge pixels of the character “T” become unclear, causing the character “T” to include a noise region N2.

Noise region N1 is described first. This noise corresponds to block noise. The above-described image processing device can specify character outline pixels. Thus, by performing noise elimination processing on pixels within the character outline, noise region N1 can be made less conspicuous.

Noise region N2 is described next. In noise region N2, the edge pixels of the character “T” are unclear. With the above-described image processing device, the outline of a character can be specified even if the character and a background have a similar color. Thus, by performing enhancement processing on an outline portion of the character, blurring of the outline of the character as in noise region N2 can be suppressed.

These types of processing are performed in character outline enhancement unit 9 in FIG. 1. While unit 9 is specified as character outline enhancement unit 9 for purposes of illustration, various types of image processing on a character such as image processing within the character outline can be performed, for example, without being limited to enhancement of the character outline.

(Applications)

The application of the above-described image processing device to a video reproducing device of a television is now generally described.

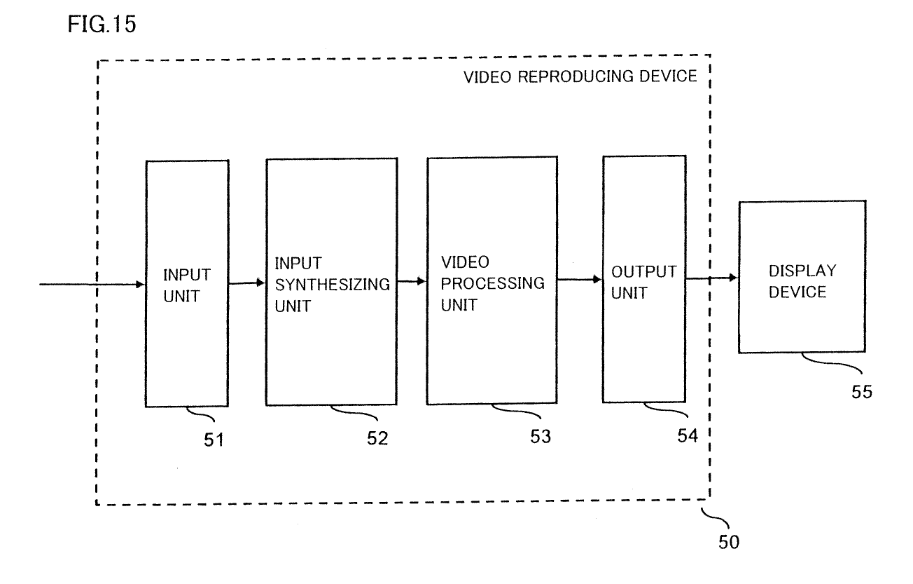

FIG. 15 shows a block configuration of a substantial part of a video reproducing device and system. A video reproducing device 50 includes an input unit 51, an input synthesizing unit 52, a video processing unit 53, and an output unit 54.

The processing of input unit 51 is described. First, a tuner included in input unit 51 performs radio processing to receive a signal of video data. The received data is sorted according to the data type and subjected to decoding processing with a decoder, to generate data in a predetermined format (a moving image plane, a character plane, a static image plane, etc.).

The processing of input synthesizing unit 52 is described next. Input synthesizing unit 52 synthesizes the data generated by the input unit to integrated video data corresponding to a display screen. Once input synthesizing unit 52 synthesizes the integrated video data, a character portion is completely buried in the video data and cannot be readily separated. When performing image processing on the character portion, therefore, it is important to accurately specify the character portion from the integrated video data.

The data synthesized by input synthesizing unit 52 is subjected to various types of image processing at video processing unit 53. For example, outline correction and noise elimination processing are performed on each type of layer. The above-described image processing device is included in image processing unit 53, and used in conjunction with a compression noise elimination circuit, thus improving image quality of the character portion. More specifically, character outline information is transmitted from the above-described image processing device to the compression noise elimination circuit, and based on that information, the compression noise elimination circuit performs the noise elimination processing within the outline.

Lastly, output unit 54 outputs the video data processed by video processing unit 53 to a display device 55.

As described above, according to the image processing device in the embodiment of the present invention based on the premise that all pixels forming character strings have the same luminance and motion vectors of the same magnitude, and that these character strings include many edge pixels, a histogram representing a frequency with which pixels having a motion vector and a luminance forming a combination are edge pixels is generated for each combination of a motion vector and a luminance of an image, to detect the position of a character. Accordingly, the position of a character in a moving image can be readily detected even if pixels of the character have a luminance not higher than a luminance of pixels other than the pixels of the character, which cannot be addressed with the method described in Patent Literature 1.

Moreover, according to the image processing device in the embodiment of the present invention, as compared to a method of detecting the position of a character in an mage by recognizing the character through pattern matching, a table and a comparison circuit for pattern matching are eliminated, thereby attaining reduced circuit dimensions.

(Modifications)

The present invention is not limited to the embodiment described above, but includes the following modifications, for example.

(1) Edge Detection

While edge detection unit 4 horizontally scans an image of a current frame, and if there is a segment including a predetermined number or more of continuous pixels having a value equal to or greater than a threshold value, detects pixels on both ends of the segment as edge pixels in the embodiment of the present invention, this is not restrictive. In addition to this, edge detection unit 4 may further vertically scan the image of the current frame, and if there is a segment including a predetermined number or more of continuous pixels having a value equal to or greater than a threshold value, detect pixels on both ends of the segment as edge pixels as well. Alternatively, other common edge detection methods such as the Canny method or a method of using secondary differentiation of luminance may be employed.

(2) Specification of Character Line

While character line specification unit 7 specifies, from among a plurality of horizontal lines forming an image of a current frame, lines including a number of pixels equal to or greater than a threshold value having a luminance the same as luminance A forming a combination of a motion vector and a luminance having a frequency equal to or higher than a threshold value as character lines in the embodiment of the present invention, this is not restrictive. Character line specification unit 7 may specify, from among a plurality of horizontal lines, lines including a number of pixels equal to or greater than a threshold value having a luminance different from luminance A by not more than a predetermined value as character lines.

(3) Motion Determination

In the embodiment of the present invention, if the magnitude of a motion vector forming a specified combination is equal to or less than threshold value TH4, motion determination unit 11 determines that the specified character lines include pixels of a static character, and if the magnitude is greater than threshold value TH4, motion determination unit 11 determines that the character lines include pixels of a moving character. Here, threshold value TH4 may be “0”.

(4) Specification of Character Outline Pixel

While character line specification unit 7 specifies, from among a plurality of horizontal lines forming an image of a current frame, lines including a number of pixels equal to or greater than a threshold value having a luminance the same as luminance A forming a combination of a motion vector and a luminance having a histogram frequency equal to or higher than a threshold value as character lines, specifies edge pixels on the character lines as character outline pixels, and specifies the character outline pixels and a pixel sandwiched between the character outline pixels as character pixels in the embodiment of the present invention, this is not restrictive. Of the edge pixels, a combination of a motion vector and a luminance having a histogram frequency equal to or higher than a threshold value may be specified, pixels having the specified motion vector and luminance may be specified as character outline pixels, and the character outline pixels and a pixel sandwiched between the character outline pixels may be specified as character pixels.

(5) Specification of Character Pixel

While character pixel specification unit 12 specifies, if a plurality of character outline pixels forming one character line successively include a pair from one end of the one character line, two pixels forming the pair and a pixel sandwiched between the two pixels forming the pair as character pixels forming a character in the embodiment of the present invention, this is not restrictive. For example, character pixel specification unit 12 may specify, from among a plurality of pixels forming one character line, pixels having a luminance the same as luminance A counted when the character line was determined as character pixels.

(6) Character Outline Enhancement

While character outline enhancement unit 9 multiplies the luminance of a character outline pixel of a static character by a factor of k1 (k1>1), multiplies the luminance of pixels horizontally adjacent to the character outline pixel by a factor of k2 (k2<1), multiplies the luminance of a character outline pixel of a moving character by a factor of k3 (k3>k1), and multiplies the luminance of pixels horizontally adjacent to the character outline pixel by a factor of k4 (k4<k2) in the embodiment of the present invention, this is not restrictive. It may be such that k1=k3 and k2=k4 are satisfied. Alternatively, the luminance of vertically adjacent pixels may be multiplied by a factor of k2 or k4, or another filter for enhancing the outline may be used.

(7) Representative Vector

While motion vector correction unit 14 sets a motion vector having the highest frequency among motion vectors of a plurality of character pixels in one character line as a representative vector in the embodiment of the present invention, this is not restrictive. For example, an average vector of motion vectors of a plurality of character pixels in one character line may be set as a representative vector. Alternatively, a representative vector of motion vectors of a plurality of character pixels in a plurality of character lines (all character lines forming “DEF” or all character lines forming “HT” in FIG. 3) obtained for one combination of a motion vector and a luminance having a histogram frequency equal to or higher than a threshold value may be obtained, and all the plurality of character pixels in the plurality of character lines may be corrected to have the representative vector. That is, a representative vector of all character pixels forming the character “DEF” is obtained to correct all these character pixels to have the representative vector, and a representative vector of all character pixels forming the character “HT” is obtained to correct all these character pixels to have the representative vector. As a result, as in the embodiment, when generating an intermediate frame by using motion vectors, the occurrence of noise in an image of the intermediate frame after interpolation can be prevented when the motion vectors include noise. Moreover, with this method, even if most motion vectors of character pixels in one character line include noise, they can be corrected to have motion vectors without noise of character pixels in another character line.

(8) Frame Interpolation

While frame interpolation unit 10 uses motion vectors to generate an image of an intermediate frame between a previous frame and a current frame from an image of the previous frame in the embodiment of the present invention, this is not restrictive. Frame interpolation unit 10 may use motion vectors to generate an image of an intermediate frame from an image of a current frame, or use motion vectors to generate an image of an intermediate frame from both an image of a current frame and an image of a previous frame.

(9) Super-Resolution System

The circuit for detecting the position of a character in the embodiment of the present invention is applicable to a super-resolution system that separates an object in an image into layers according to the object type, and performs image processing on each layer. In particular, when the circuit for detecting the position of a character in the embodiment of the present invention is used, a layer of a character portion (character string) can be accurately extracted, thereby effectively performing image processing on the characters.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 image processing device; 2 frame memory; 3 memory controller; 4 edge detection unit; 5 histogram generation unit; 6 character position detection unit; 7 character line specification unit; 8 character outline pixel specification unit; 9 character outline enhancement unit; 10 frame interpolation unit; 11 motion determination unit; 12 character pixel specification unit; 13 motion vector generation unit; 14 motion vector correction unit; 50 video reproducing device; 51 input unit; 52 input synthesizing unit; 53 video processing unit; 54 output unit; 55 display device.

1. An image processing device comprising:
a motion vector generation unit for generating motion vectors of an image of a first frame and an image of a second frame;
an edge detection unit for detecting an edge pixel forming an edge of said image of said first frame; and
a character position detection unit for detecting a position of a character included in said image of said first frame based on a motion vector, a luminance, and information about whether or not being said edge pixel, of each pixel of said image of said first frame.

2. The image processing device according to claim 1, wherein
said character position detection unit detects said position of said character based on a frequency with which pixels having a motion vector and a luminance forming a combination are the edge pixels, for each combination of a motion vector and a luminance of said image of said first frame.

3. The image processing device according to claim 2, wherein
said character position detection unit includes
a histogram generation unit for generating a histogram representing a frequency with which pixels having a motion vector and a luminance forming a combination are the edge pixels, for each combination of a motion vector and a luminance, and
a character line specification unit for specifying a combination of a motion vector and a luminance having said frequency equal to or higher than a predetermined value, and specifying, from among a plurality of horizontal lines forming said image of said first frame, a line including a predetermined number or more of pixels having a luminance different from the luminance forming said specified combination by not more than a predetermined value as a character line including a pixel of the character.

4. The image processing device according to claim 3, wherein
said character position detection unit further includes a motion determination unit for determining, if magnitude of the motion vector forming the combination having said frequency equal to or higher than the predetermined value is equal to or less than a predetermined value, that said character line includes a pixel of a static character whose position is not changed between said first frame and said second frame, and if the magnitude is greater than said predetermined value, determining that said character line includes a pixel of a moving character whose position is changed between said first frame and said second frame.

5. The image processing device according to claim 3, wherein
said character position detection unit further includes a character outline pixel specification unit for specifying, from among a plurality of pixels included in said character line, a pixel which is said edge pixel as a character outline pixel forming an outline of the character.

6. The image processing device according to claim 5, wherein
said character position detection unit further includes a character pixel specification unit for specifying, if a plurality of character outline pixels included in one character line successively include a pair from one end of said one character line, two pixels forming said pair and a pixel sandwiched between the two pixels forming said pair as character pixels forming the character.

7. The image processing device according to claim 6, further comprising a motion vector correction unit for specifying a representative vector representing motion vectors of the plurality of character pixels included in the one character line, and correcting any of the motion vectors not identical to said representative vector of the plurality of character pixels included in said one character line to said representative vector.

8. The image processing device according to claim 6, further comprising a motion vector correction unit for specifying a representative vector representing motion vectors of the plurality of character pixels included in said plurality of specified character lines, for one combination of a motion vector and a luminance having said frequency equal to or higher than the predetermined value, and correcting any of the motion vectors not identical to said representative vector of the plurality of character pixels included in said plurality of character lines to said representative vector.

9. The image processing device according to claim 7, further comprising a frame interpolation unit for using said corrected motion vector to generate an interpolation frame between said first frame and said second frame from at least one of said image of said first frame and said image of said second frame.

10. The image processing device according to claim 5, further comprising a character outline enhancement unit for performing enhancement processing on said character outline pixel.

11. The image processing device according to claim 10, wherein
said character position detection unit further includes a motion determination unit for determining, if magnitude of the motion vector forming the combination having said frequency equal to or higher than the predetermined value is equal to or less than a predetermined value, that said character line includes a pixel of a static character whose position is not changed between said first frame and said second frame, and if the magnitude is greater than said predetermined value, determining that said character line includes a pixel of a moving character whose position is changed between said first frame and said second frame, and
said character outline enhancement unit enhances the character outline pixel included in the character line that has been determined to include said static character with a first degree of enhancement, and enhances the character outline pixel included in the character line that has been determined to include said moving character with a second degree of enhancement higher than said first degree of enhancement.

12. The image processing device according to claim 1, wherein
said edge detection unit horizontally scans said image of said first frame, and if there is a segment including a predetermined number or more of continuous pixels having a value equal to or greater than a predetermine value, detects both ends of said segment as said edge pixels.

13. A video reproducing device comprising:
an input unit for externally receiving video data and performing decoding processing;
a synthesis unit for synthesizing data in said video data to integrated video data corresponding to a display screen;
an image processing unit for performing predetermined image processing on said video data; and
an output unit for outputting said video data that has been subjected to said image processing to a display device,
said image processing unit including the image processing device according to claim 1.

14. The video reproducing device according to claim 13, wherein
said image processing unit further includes a noise elimination unit for performing noise elimination operation within a character region based on detection information from said image processing device.
